(19) United States
(12) Patent Application Publication
(10) Pub. No.: US 2013/0147349 A1
(43) Pub. Date: Jun. 13, 2013

(54) INTEGRAL STARTER FOR ELECTRODELESS LAMP

(71) Applicants: Jianwu Li, Louisville, KY (US); David C. Dudik, Shaker Heights, OH (US); Viktor Karoly Varga, Solon, OH (US); Joshua Ian Rintamaki, Westlake, OH (US)

(72) Inventors: Jianwu Li, Louisville, KY (US); David C. Dudik, Shaker Heights, OH (US); Viktor Karoly Varga, Solon, OH (US); Joshua Ian Rintamaki, Westlake, OH (US)

(73) Assignee: General Electric Company

(21) Appl. No.: 13/313,864

(22) Filed: Dec. 7, 2011

(51) Int. Cl. H01J 65/04

(52) U.S. Cl. 315/34

(57) ABSTRACT

A high intensity discharge (HID) or ceramic HID lamp includes a main envelope having a gas fill that is selectively energized to produce visible light. An RF coil surrounds a light emitting portion of the main envelope, and an envelope extension or starting leg has a cavity that either contains a low pressure ionizable fill material to ionize at a level below the gas fill of the main envelope, or receives a high voltage potential conductor wire extending therethrough to serve as a starting assembly.

### BACKGROUND OF THE DISCLOSURE

This application relates to a high intensity discharge (HID) lamp, and particularly to an electrodeless or induction HID lamp, and more particularly to an electrodeless or induction ceramic HID lamp. These types of electrodeless lamps include an arc body having a chamber that contains a fill gas and a coil closely positioned adjacent the arc body that creates a toroidal arc discharge in the body. Typically, a radio frequency (RF) coil is disposed about a perimeter portion of a spheroidal portion of the arc body. In order to maximize the amount of visible light output from the arc body, it is desirable that the number and size of the RF coils be minimized, and that other lamp components not adversely interfere with the light output from the lamp.

Starting an induction HID lamp requires an initial input of energy to ionize at least part of the lamp fill and initiate a breakdown to form an ignited gas plasma. In an electrodeless lamp, an external starter requires additional processing and manufacturing when compared to an internal starting assembly. Likewise, an external starter reduces the optical efficiency of the system by undesirably blocking light from the lamp. On the other hand, positioning a starter inside the lamp simplifies the system and eliminates the light blockage from the external starter construction.

The assignee of the present application previously developed a quartz electrodeless lamp of the type shown and described in U.S. Pat. No. 5,151,653, the disclosure of which is hereby expressly incorporated herein by reference. A starting tube containing an ionizable gas was attached to one side of the arc tube or a Tesla coil was placed externally near the lamp. In both cases, the starting structure was large and external to the lamp. Unfortunately, this starting structure reduced light emanating from the lamp and presents the issues of arcing from the high voltage coil to the induction coil and other parts of the lamp system.

The electrodeless lamp arrangement shown and described in U.S. Pat. No. 5,151,653 also requires additional components with associated system costs. Moreover, it is difficult to maintain a close proximity of the starter to the main lamp body, and particularly obtaining close proximity without impacting on light output from the lamp.

U.S. Pat. No. 5,637,963 assigned to Toshiba Lighting & Technology Corporation discloses an electrodeless lamp with a starting tube filled with gas disposed inside a leg of the lamp. The gas tilled starting tube is a separate assembly that is placed inside the leg, and subsequently sealed in the leg. An ionizable gas such as argon, xenon, Krypton, neon, or mixtures thereof is placed in the hollow tube to initiate lamp operation. For example, the gas in the starting tube is at a low pressure on the order to 13 kpa while the rare gas disposed in the primary or main envelope is at a higher pressure on the order of 33 kpa. In this known arrangement, there is also a space formed between the starter tube and the leg of the arc body.

A need exists for an improved starting arrangement and methods that can be integrated into the main body of the electrodeless ceramic HID lamp. These starting methods will enable the use of a ceramic lamp body which has known performance advantages over the prior art quartz lamps.

### SUMMARY OF THE DISCLOSURE

An improved high intensity discharge lamp or ceramic HID lamp includes a main envelope having a chamber containing a gas fill that is selectively energized to emit visible light. An RF coil surrounds a light emitting portion of the main envelope, and an envelope extension has a cavity sealed from the chamber that contains a low pressure gas that will ionize at a level below the gas fill in the main envelope, or a starting wire extends through the envelope extension for starting the main fill. A partition extends between the main envelope chamber and the envelope extension cavity that is permeable to UV photons passing from the cavity to the main envelope chamber to facilitate starting of the discharge in the main envelope chamber.

Preferably, the arc body is a substantially elliptical or spheroidal portion, and an envelope extension is substantially smaller in cross sectional dimension.

The partition forms a part of the wall of the main envelope chamber. A conductor communicates with a distal end of the envelope extension, and establishes a capacitive charge across the ionizable starting fill. Once the starting fill is ionized, UV photons pass through the wall into the main envelope to facilitate ignition of a main envelope fill.

Another preferred arrangement eliminates the use of a separate starting fill and instead supplies a high voltage potential wire through the extended open leg. The high voltage potential wire terminates adjacent the main envelope within the leg. The high voltage potential wire cooperates with the RF coil to initiate startup of the discharge of the main fill.

In yet another embodiment, a leg extends from the main envelope and communicates with a main fill. A first high voltage wire is situated adjacent a first polar region of the main envelope while the leg extends from a second polar region.

A primary advantage of the present disclosure resides in the ability to reduce facilitate startup or ignition of the main envelope.

Another advantage of this disclosure resides in the limited impact on the light output of the lamp.

Still another benefit is associated with the ease of assembling an integral lamp.

Yet another benefit is that this method also eliminates the need for a high voltage pulse that can potentially damage the arctube material or RF electrical components.

Still other benefits and advantages of the present disclosure will become apparent from reading and understanding the following detailed description.

### BRIEF DESCRIPTION OF THE DRAWINGS

FIG. 1 is a first embodiment shown in sectional view of an electrodeless discharge lamp where an ionizable fill is integrated inside a leg.

FIG. 2 is a sectional view of a second embodiment of an electrodeless discharge lamp that includes an ionizable starting fill included in the leg.

FIG. 3 is a sectional view of a third embodiment of an electrodeless discharge lamp that integrates a high voltage potential wire inside the arctube leg.

FIG. 4 is sectional view of a high voltage potential wire molded into the leg seal according to a fourth embodiment.

FIG. 5 is a sectional view with envelope extensions extending from opposite ends, and with an ionizable starting fill integrated in one extension.

FIG. 6 is a sectional view of a sixth embodiment that includes first and second legs extending from opposite ends of the main envelope, and a high voltage potential wire inside one leg.

FIG. 7 is a sectional view in which first and second legs extend from the same end of the main envelope body, and an ionizable starting fill integrated in one leg.

FIG. 8 is a sectional view in which the first and second legs extend from the same side of the main envelope body, and a high voltage potential wire integrated in one leg.

FIG. 9 illustrates the first and second legs extending from one side of the main envelope body that simplifies manufacture.

FIG. 10 shows an embodiment similar to FIG. 9 in which a conductive wire replaces the ionizable gas fill for starting purposes.

FIG. 11 is a sectional view of another embodiment in which the dosing leg and the starting fill leg are molded together.

### DETAILED DESCRIPTION OF THE PREFERRED EMBODIMENTS

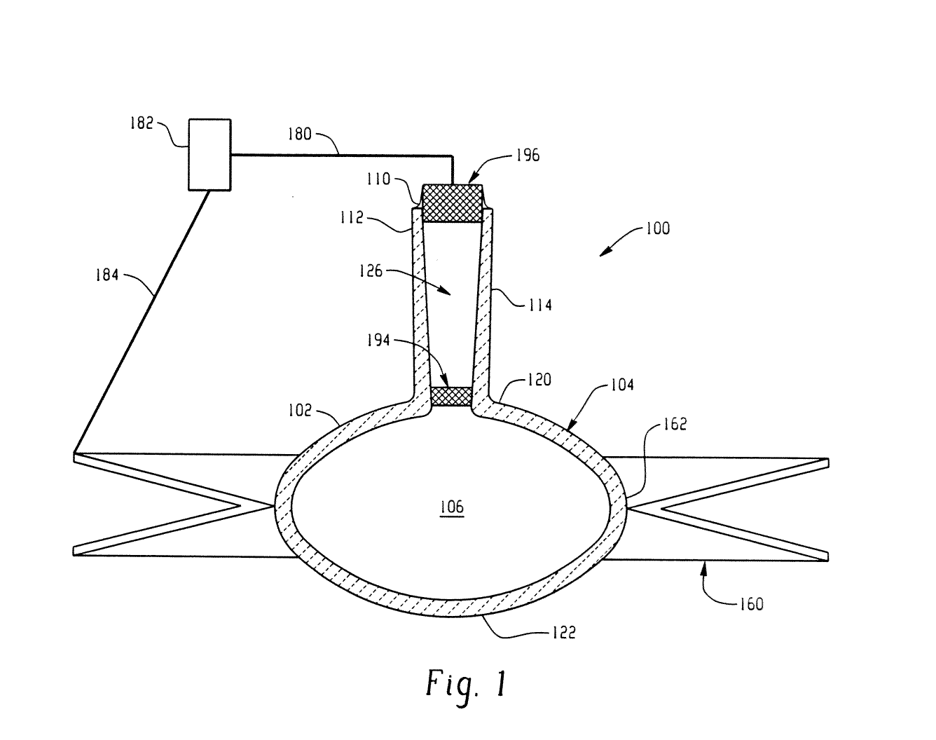

Turning initially to FIG. 1, there is shown a first embodiment of an integral starter for an electrodeless high intensity discharge (HID) or ceramic HID lamp assembly 100. The lamp assembly includes a main envelope or arc body 102. The arc body 102 preferably has an ellipsoidal or generally spheroidal shape that serves as a main envelope or ceramic lamp body 104 enclosing a similarly shaped cavity or main chamber 106 that contains a desired main fill. The main chamber 106 is hermetically sealed from the external or ambient environment, and in the embodiment of FIG. 1 includes a seal 110 at an outer or distal end 112 of a first leg 114 extending from the body 104. The seal 110 could also be a co-sintered joint between the starting tube and first leg 114. The main chamber 106 is hermetically sealed after the main fill has been introduced or dosed into the arc body 104. The arc body is preferably made from a ceramic material that is light transmissive, such as polycrystalline alumina, although other materials may be used where conducive to the demands or needs of the electrodeless lamp.

The leg 114 extends from a first polar region 120 of the main body 104. A second polar region 122 does not include any leg or extension in the embodiment of FIG. 1. The first leg 114 is hollow and inner wall 124 forms a cavity 126. In this arrangement of FIG. 1, the first leg 114 has a tapering sidewall thickness that reduces in thickness as it extends axially away from the first polar region 120. That is, interior wall 124 of the leg 114 tapers inwardly (reduces in cross-section) from outer, distal end 112 and as the first leg proceeds toward the polar region 120 while an outer dimension of the first leg remains substantially constant in this embodiment. In this manner, the thickness of the wall of the leg 114 is greater near the polar region than at the distal end, and the cross-sectional dimension of the cavity adjacent the polar region 120 is slightly smaller than the outer dimension of first end 144 of the starting tube to provide a supporting, abutting engagement of the starting plug. Thus, in this arrangement the wall is tapered, although it will be appreciated that an alternative configuration could likewise be used to support the leg 114 without departing from the scope and intent of the present disclosure. After the light-emitting fill species has been introduced into the main chamber 106 through the leg 114, the first starting seal 194 seals the main chamber 106 and creates the leg cavity 126. The ionizable starting fill then fills the leg cavity 126. After that, the second starting plug or seal 196 seals the leg cavity 126. As will be appreciated, the light-emitting fill species may contain different materials, however, the fill usually includes the halide in the main body and in one preferred arrangement, is at a pressure on the order of approximately 300 Torr. The ionizable gas fill received in the leg 114 may be any well-known ionizable gas such as argon, xenon, krypton, neon, or mixtures thereof, while the light-emitting fill in the main chamber 106 may include an arc discharge sustaining medium such as sodium iodide, scandium iodide, neodymium iodide, cesium iodide and paraseodium iodide, while at least one gas selected from the group of argon, xenon, and neon is used as the inert gas. Again, the material and the pressures may differ depending on desired results. The ionizable fill in the leg 114, on the other hand, is at a lower pressure on the order of approximately 10 Torr.

A radio frequency or RF coil 160 generally extends about an equatorial or median region 162 of the arc body 102. The RF coil 160 is preferably a multi-turn assembly, such as the illustrated coil that includes first and second turns. The coil preferably has a low profile and therefore does not significantly impact light output from the main chamber. The coil is preferably closely disposed adjacent a perimeter of the equatorial region 162 in order to provide energy to the fill and continue to power the arc discharge once ignition of the fill has been initiated.

A high voltage conductor or wire 180 extends from a high voltage power source or electrical circuit such as an LC circuit 182 and terminates at an outer end of the leg 114 (or plug 196) in the embodiment of FIG. 1. In addition, a wire or conductor 184 proceeds from the power source 182 for connection with the RF coil 160. The operation of the circuit is well understood in the art, for example as shown and described in U.S. Pat. No. 5,136,214, so that further discussion is deemed unnecessary to understanding the present disclosure. The low pressure, ionizable fill in the leg 114 initiates a discharge at a lower voltage, and once the discharge is established, UV photons pass through the plug 194 and excite the ions within the light emitting fill species inside cavity 106. Once the discharge in the main envelope is initiated, the conductor 180 is de-energized and the power required for maintaining the discharge is then provided by the RF coil 160. Other starting methods to excite the ionizable fill that are known in the art are also envisioned for the disclosed integral starter.

The first leg 114 forms a starting member that uses an ionizable gas fill and therefore the first seal 194 adjacent the first end of the leg where the leg merges into the first polar region 120 of the main body segregates the starting fill from the main fill. Once the main light emitting fill species dose is introduced into cavity 106 of the main body through the first leg 114, the first seal 194 is positioned in place preferably along or adjacent the polar region 120 where the first leg intersects with the main body. Subsequently, an ionizable or starting fill is introduced into the leg cavity 126 and thereafter the second seal 196 is provided at the outer or distal end of the leg 114 to maintain the ionizable starting fill. This allows a different fill material to be used to initiate startup, and thereafter the emitted UV photons pass through the seal and ceramic leg in order to initiate ignition of the main fill.

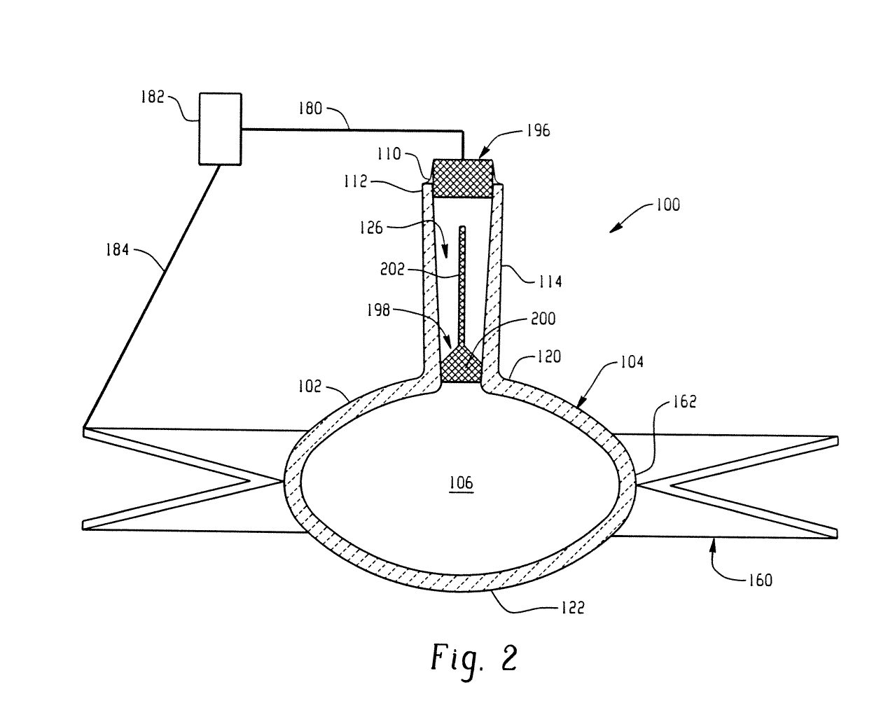

In FIG. 2, modification of the first seal (referenced here as “first seal 198”) includes an enlarged seal portion 200 and an elongated stem 202 that preferably extends axially therefrom. The stem 202 is preferably of reduced dimension relative to the enlarged seal portion to allow the first seal 198 to be positioned at a desired location adjacent the polar region 120. The ionizable starting fill is then introduced into the leg 114, and subsequently the second seal 196 positioned in place at the outer, distal end of the leg. It will also be appreciated by one skilled in the art that the extension 202 may originally be formed at a length that extends a greater distance through the first leg 114 and is then shortened or reduced in length during the manufacturing process, e.g., after the first seal is positioned in place and before the second seal 196 is complete. Again, in substantially all other respects, the embodiment of FIG. 2 is substantially structurally and operationally similar to the embodiment of FIG. 1.

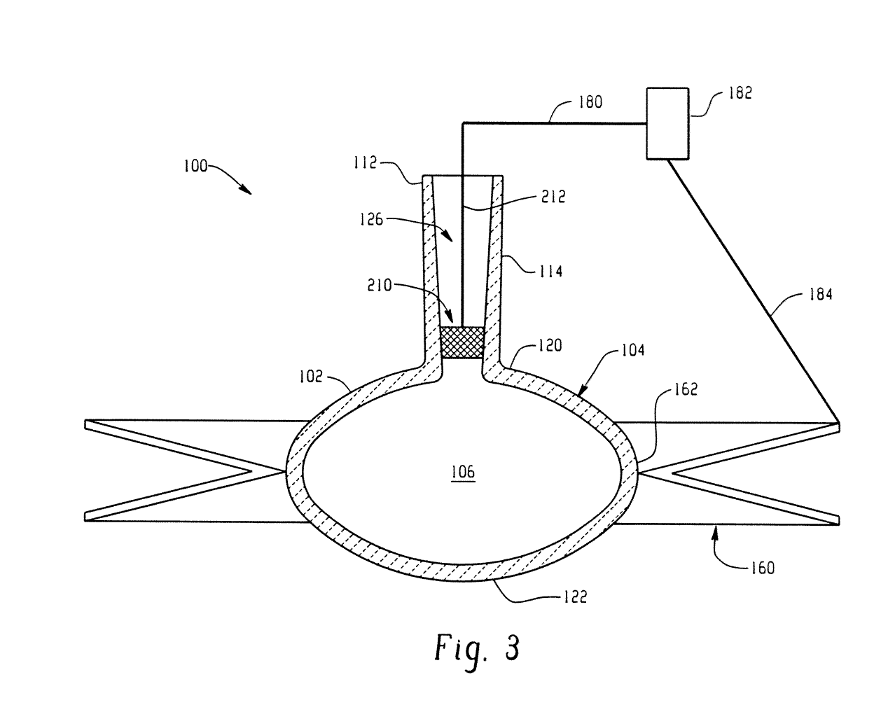

In the embodiment of FIG. 3, the leg receives a leg seal 210. Particularly, the leg seal 210 is preferably located adjacent the interface between the leg and the main body after the main fill has been introduced into the main body through the leg. High voltage potential wire 212 is then extended into the leg and is connected to or an extension of conductor or wire 180 extending from the high voltage generator 182 so that the desired potential between conductor wire 212 and the RF coil 160 can be established to initiate discharge in the main chamber. An additional advantage of the high voltage potential wire 212 being placed integrally inside the leg 114 is the insulation of the high voltage from the induction coil and other parts of the lamp system. In substantially all other respects, this embodiment is structurally and functionally the same as the previously described embodiments.

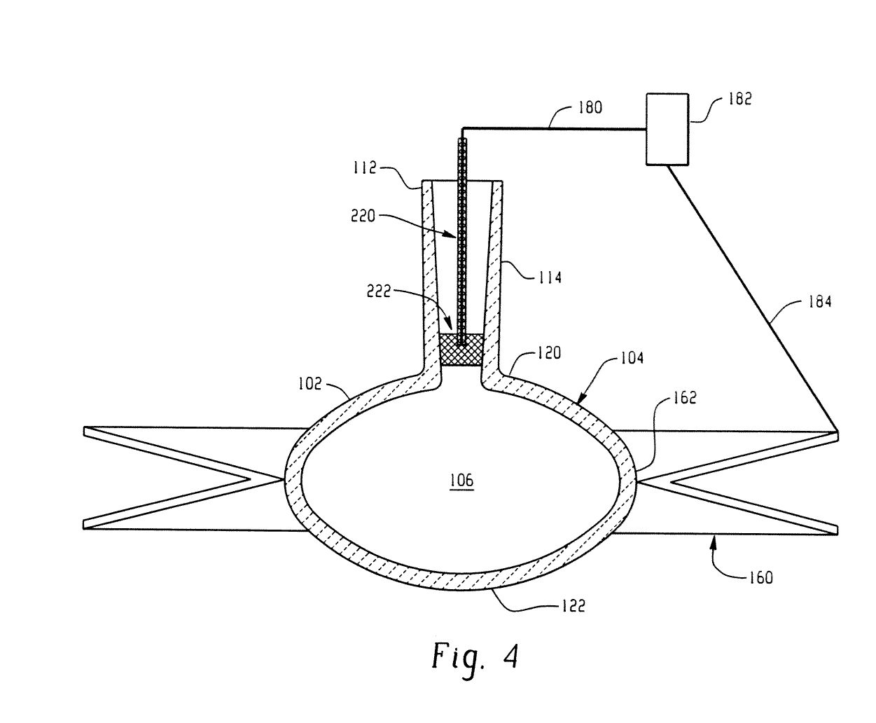

FIG. 4 is a slight variation of the embodiment of FIG. 3. Here, one end of the high voltage potential conductor or wire 220 is molded into leg seal 222 and at the other end, the wire 220 is operatively connected to the high voltage generator 182 via conductor 180. This is desirable in an effort to reduce separate manipulation of various components during the fill and sealing process. That is, the main fill is introduced through the first leg 114 into the main body, and then the leg seal 222 is introduced by manipulating the high voltage potential conductor 220 in the open end of the leg to position the leg seal 222 adjacent the main body. An additional advantage of the high voltage potential wire 212 being placed integrally inside the first leg 114 is the insulation of the high voltage from the induction coil and other parts of the lamp system.

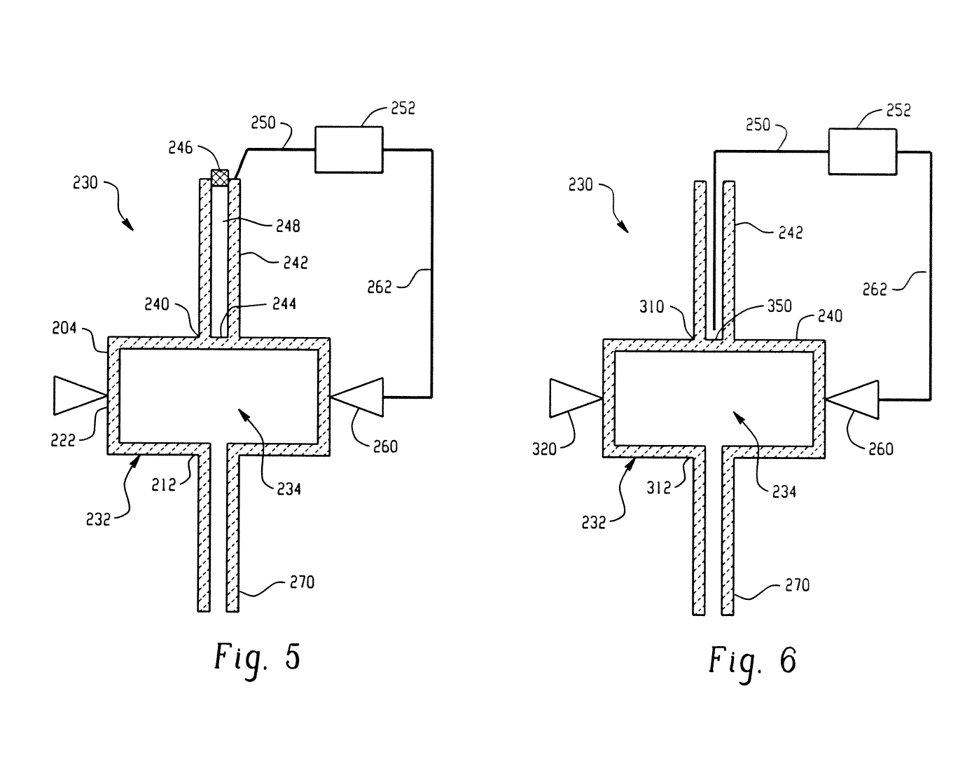

Still another modified embodiment is shown in FIG. 5. The lamp assembly 230 is represented with a main body 232 shown in generally rectangular cross-section, although these concepts are equally applicable to the spheroidal shape of FIGS. 1-4. The main body 232 encloses a main cavity 234 that receives the fill. Extending from a first or upper central region 240 is a first leg 242 that is partitioned by wall 244 from the main envelope and sealed at a second or distal end by seal member 246 to contain an ionizable fill 248 in the leg cavity. A conductor or wire 250 extends from a power source or electrical circuit such as an LC circuit 252 where the wire is then connected to the outer end of the first leg. In addition, an RF coil 260 surrounds the main body in much the same manner as described in the prior embodiments and is also connected to the power source 252 via conductor line 262. Also extending outwardly from the main body is a second or dosing leg 270, shown here as extending in the opposite axial direction from the first leg. i.e., from the lower polar region of the main body. A uniaxial orientation of legs is shown for illustration, but other angular orientations of the legs on the upper and lower polar regions is also contemplated. The dosing leg 270 is used to introduce the main fill into cavity 234 of the main body 232 and is subsequently sealed. By establishing an electrical potential between conductors 250, 262, the ionizable fill in the first leg 242 is energized or excited so as to produce energetic photons that, in turn, ignite the main fill. Once ignition is complete, power continues to be supplied to the main fill via the RF coil 260. Although shown open for ease of illustration, it will be understood that the dosing leg 270 is subsequently pinched or sealed once the main fill has been introduced.

The embodiment of FIG. 6 bears some similarities to the embodiment of FIG. 5, and therefore the same reference numerals are used for purposes of brevity and ease of understanding. In FIG. 6, first leg 242 extends from the upper region of the main envelope, while the second leg 270 extends in the opposite direction from a lower portion of the main envelope. The primary difference is that the first leg 242 is not a sealed cavity and instead the conductor 250 (or separate wire/conductor connected to conductor 250) extends through the length of the first leg 242 and terminates adjacent the partition wall 240. The electrical potential between the conductor 250 received in the first leg and the RF coil 260 which is powered by conductor 262 extending from power source 252 provides the desired ignition voltage, and subsequent power to continue excitation of the ionizable fill gas contained in the main body 232 is provided by the power generator 252 through the RF coil 260. The two legs embodiment of FIG. 5 and FIG. 6 will provide the advantage to better support the main body inside the lighting system.

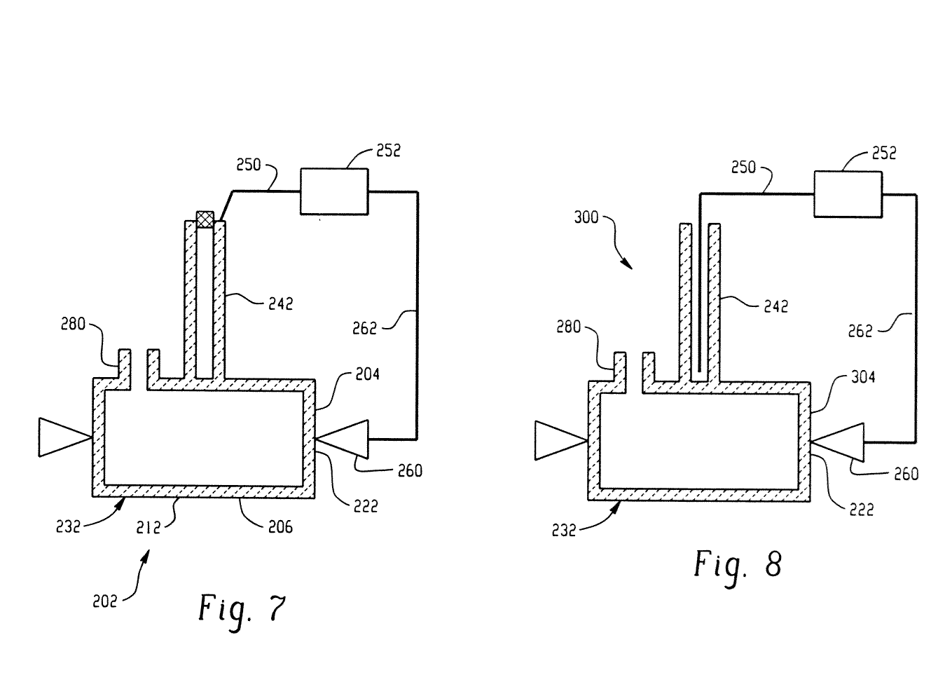

FIG. 7 also includes similarities to the embodiment of FIG. 5 so that, again, like reference numerals will refer to like components and new components will be identified by new reference numerals. The primary distinction is that dosing leg 280 in the embodiment of FIG. 7 extends from the same side or in generally parallel relation from the upper surface of the main body 232. The first leg 242 is hermetically sealed to contain the ionizable fill, such as a noble or ionizable gas, so that the conductor 250 initiates ignition in the starting leg 242. This leads to ignition of the main fill which light emission is then continued via power supplied through the RF coil 260.

FIG. 8 bears similarities to both of the embodiments of FIGS. 6 and 7. That is, dosing leg 280 extends from the same side of the main body as the starting leg 242. In this arrangement, the starting leg 242 is not a hermetically sealed enclosure but rather is open at the outer, distal end so that a conductor (such as a high voltage potential wire 250) can extend through the starting leg 242 to serve as the starting member and initiate gas discharge.

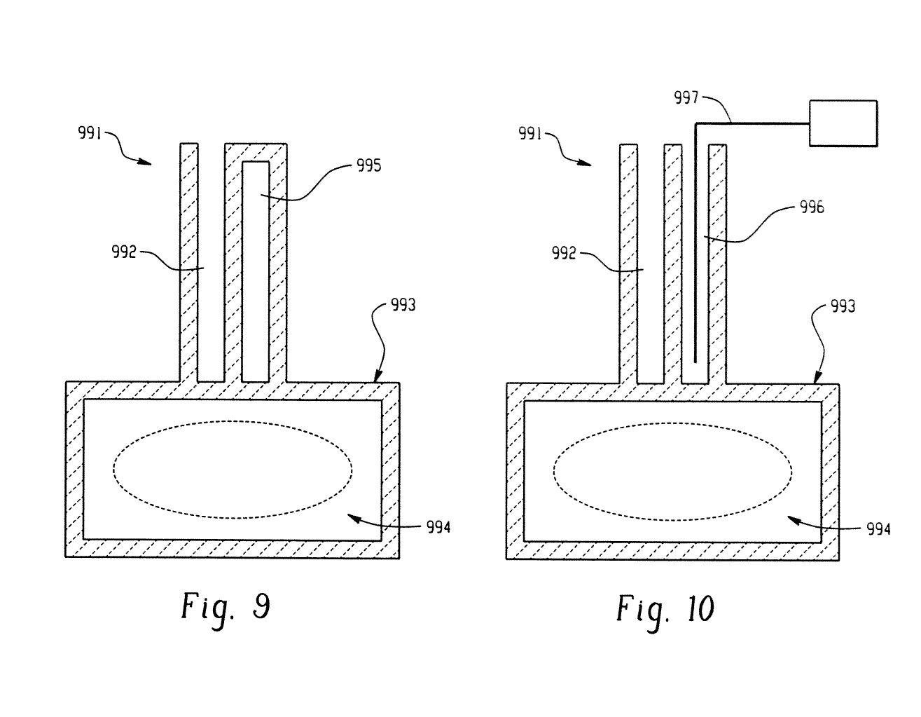

FIG. 9 shows a similar embodiment to FIG. 7, with the addition of a single leg structure 991 with multiple functions. Dosing and filling of the lamp is conducted through a dosing feedthrough 992 in communication with the main arc chamber 994. A second feedthrough 995 contains an ionizable fill gas or starting tube, similar to FIGS. 1, 2, 5, and 7. An additional advantage is gained in the ease of manufacturing this shape by injection molding. Blocking of light from the arc body 993 is also reduced as a single leg contains both starting and dosing functions. For ease of illustration, the remaining structure of the lamp assembly has been omitted although it will be appreciated that the embodiment of FIG. 9 includes the same features of seals for the legs, dose, RF coil, high voltage power source, etc. as used in the previously described embodiments.

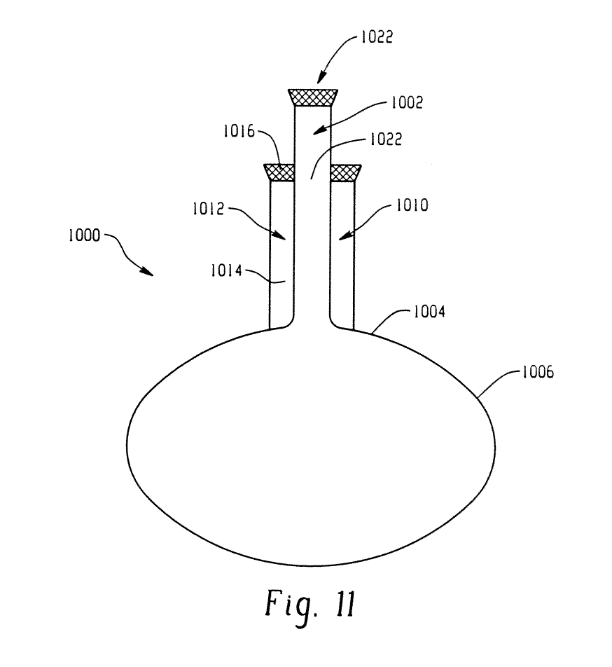

FIG. 10 shows a similar embodiment to FIG. 9, with a conductive starting wire replacing the ionizable gas fill as the starting method. Dosing and filling of the lamp is conducted through a dosing feedthrough 992 in communication with the main arc chamber 994. A second feedthrough 996 contains conductive starting wire 997, similar to FIGS. 3, 4, 6, and 8. Again, the remaining structure of the lamp assembly has been omitted although it will be appreciated that the embodiment of FIG. 10 likewise includes the same features of seals for the legs, dose, RF coil, high voltage power source, etc. as used in the previously described embodiments.

FIG. 11 discloses yet another embodiment of a ceramic HID lamp assembly 1000 in which a first or main fill dose leg 1002 extends from a first polar region 1004 of main arc body 1006. A starting fill leg 1010 is molded around at least an axial length or a portion of the main fill dose leg 1002. That is, the starting fill leg 1010 is concentrically molded around the dose leg 1002 so that an inner wall of the starting fill chamber 1012 is defined by the dose leg 1002. Further, a base region of the starting fill chamber 1012 is closed off and defined by the outer surface of the arc body 1006, while an opposite, outer end of the starting fill chamber 1012 is left open until a starting fill 1014 is introduced into the starting fill chamber and then the outer end is sealed, for example by plug 1016. Likewise, main fill or dose 1020 is introduced through the dose leg 1002 into the arc body 1006 and subsequently, the a dose leg seal or plug 1022 is provided at the end of the leg spaced from the arc body 1006.

As will be appreciated, various embodiments present various modifications for ease of assembly and alternative starting arrangements. The starting and/or dosing legs may be integrally molded with the main ceramic body or in some instances are separate components that are subsequently joined together.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A discharge lamp comprising:
a main envelope having a chamber containing a gas fill that is selectively energized to produce a discharge and emit visible light from the main envelope;
an RF coil surrounding at least a portion of the main envelope; and
a starting member leg extending outwardly from the main envelope having a first seal between the main envelope chamber for sealing the gas fill in the main envelope and including one of:
an ionizable gas received in the starting member leg and a second seal spaced from the first seal for enclosing the ionizable gas therein so that UV photons will pass from the starting member leg to the chamber to facilitate starting of the discharge in the chamber; and
a starting wire extending through the leg and including a terminal end disposed adjacent the main envelope chamber.

2. The lamp of claim 1 wherein the starting wire is molded in the first seal.

3. The lamp of claim 1 further comprising a fill leg extending from the main envelope for introducing the gas fill into the chamber.

4. The lamp of claim 3 wherein the first seal is received in the fill leg adjacent the main envelope.

5. The lamp of claim 1 wherein the low pressure ionizable fill material will ionize at an energy level below the gas fill of the main envelope.

6. The lamp of claim 1 wherein the starting member leg is closed at one end, and receives a second seal at an outer end through which an ionizable fill gas is introduced prior to positioning the second seal.

7. The lamp of claim 1 wherein the starting wire is received through an open end of the starting member leg.

8. The lamp of claim 1 wherein the main envelope has an elliptical portion and the starting member leg has a substantially smaller cross-sectional dimension than the elliptical portion.

9. The lamp of claim 1 wherein the first seal forms a part of a wall of the main envelope chamber.

10. The lamp of claim 1 wherein the starting member leg is integral to the main chamber.

11. The lamp of claim 1 further comprising a dosing leg that communicates with the main chamber.

12. The lamp of claim 11 wherein the dosing leg extends from the same side of the main body as the starting member leg.

13. The lamp of claim 11 wherein the dosing leg contains the starting member leg.

14. The lamp of claim 11 wherein the dosing leg extends from an opposite side of the main body as the starting member leg.

15. A ceramic discharge lamp comprising:
a main body having a chamber containing a gas fill that is selectively energized to produce a discharge and emit visible light from the main body;
an RF coil surrounding a light emitting portion of the main body;
an extension having spaced first and second ends wherein the first end extends outwardly from a first region of the main body, and having a cavity sealed from the chamber; and
a starting conductor extending into the extension.

16. The discharge lamp of claim 15 further comprising a first seal that seals the extension.

17. The discharge lamp of claim 16 wherein the first seal includes an elongated stem that extends at least partially along a length of the extension.

18. The discharge lamp of claim 16 further comprising a second seal at a distal end of the extension.

19. The discharge lamp of claim 16 further comprising a dosing tube disposed adjacent the extension.

20. The discharge lamp of claim 15 further comprising a dosing leg spaced from the extension.

21. The discharge lamp of claim 20 wherein the dosing leg extends from a same side of the main body as the extension.

22. The discharge lamp of claim 20 wherein the dosing leg extends from a different side of the main body as the extension.

23. The discharge lamp of claim 15 wherein the extension receives an ionizable fill gas for starting the lamp.

24. The discharge lamp of claim 15 wherein the conductor extends along at least a portion of the length of the extension.

25. The discharge lamp of claim 24 further comprising a first seal that seals the extension wherein the conductor is integrally connected to the first seal.

26. The discharge lamp of claim 15 wherein a dosing leg and a main fill leg extend in concentric relation from a polar region of the arc body.
